(19) United States
(12) Patent Application Publication
(10) Pub. No.: US 2023/0170485 A1
(43) Pub. Date: Jun. 1, 2023

(54) Carbon Nanotube Dispersion Paste, Method for Manufacturing Carbon Nanotube Dispersion Paste, Quality Control Method for Carbon Nanotube Dispersion Paste, Composite Material Paste, Electrode for Lithium-Ion Battery Positive Electrode, and Lithium-Ion Battery

(71) Applicant: Kansai Paint Co., Ltd., Hyogo (JP)

(72) Inventors: Yutaro ICHI, Hiratsuka-shi (JP); Yuji HIROSE, Hiratsuka-shi (JP)

(21) Appl. No.: 17/989,752

(22) Filed: Nov. 18, 2022

(30) Foreign Application Priority Data
Nov. 30, 2021 (JP) 2021-194478

(51) Int. Cl. H01M 4/62; H01M 10/0525; H01M 4/131; C01B 32/174

(52) U.S. Cl. CPC H01M 4/625; H01M 10/0525; H01M 4/131; C01B 32/174; H01M 2004/028

(57) ABSTRACT

A carbon nanotube dispersion paste includes carbon nanotubes (B), and an organic solvent (C), in which a content of the carbon nanotubes (B) is 1% to 10% by mass with respect to a total mass of the carbon nanotube dispersion paste, and, in a Bode plot obtained by impedance measurement, in which a reactance is plotted on a vertical axis and a frequency is plotted on a horizontal axis, a local minimum value of the reactance is in a frequency range of 50 to 250 kHz.

### BACKGROUND OF THE INVENTION

### Field of the Invention

The present invention relates to a carbon nanotube dispersion paste, a method for manufacturing a carbon nanotube dispersion paste, a quality control method for a carbon nanotube dispersion paste, a composite material paste, an electrode for a lithium-ion battery positive electrode, and a lithium-ion battery.

Priority is claimed on Japanese Patent Application No. 2021-194478, filed on Nov. 30, 2021, the content of which is incorporated herein by reference.

### Description of Related Art

A lithium-ion battery is a type of non-aqueous electrolyte secondary battery in which lithium ions in the electrolyte are responsible for electrical conduction in the secondary battery. Lithium-ion batteries have excellent characteristics such as high energy density, excellent charge energy retention characteristics, and the so-called memory effect, by which the apparent capacity thereof is reduced, being low. Accordingly, lithium-ion batteries are used in a wide range of fields such as mobile phones, smartphones, personal computers, hybrid vehicles, and electric vehicles.

Here, the lithium-ion battery mainly has an electrode for a positive electrode, an electrode for a negative electrode, a separator to insulate the electrode for a positive electrode and the electrode for a negative electrode, a non-aqueous electrolyte, and the like. The electrode for a positive electrode described above has a positive electrode composite material layer formed on the surface of a positive electrode core material. It is possible to manufacture the positive electrode composite material layer by coating a positive electrode composite material paste, in which an electrode active material is mixed with a conductive paste (also called a “conductivity aid dispersion paste”) including a conductivity aid such as carbon nanotubes, a binder, and a solvent, on the surface of the positive electrode core material and then drying the result.

For example, Japanese Unexamined Patent Application, First Publication 2014-107191 discloses a carbon nanotube dispersion slurry including carbon nanotubes and a dispersing medium, in which the viscosity is 100 to 5000 mPa·s, the maximum particle size is 20 μm or less, and the concentration dependence of the admittance obtained by AC impedance measurement is 30 μS/% by mass or less.

### SUMMARY OF THE INVENTION

For a conductivity aid dispersion paste, it is preferable to have a low viscosity in a case of considering workability, stability of the positive electrode composite material paste, coatability, and the like.

In addition, in recent years, there has been a demand for further improvement of the battery performance for lithium-ion batteries. Conductivity varies greatly depending on what the dispersion state of the conductivity aid present around the electrode active material in the positive electrode composite material layer of the electrode for a positive electrode is and this also affects the battery performance.

Conductivity aids form a structure in which a plurality of primary particles are connected in a chain-like structure (referred to below as “chain structure” or “structure”). For example, as shown in FIG. 1(a), when the interaction of primary particles 10 of a conductive pigment, which is an example of a conductivity aid, is excessively strong such that the primary particles of the conductive pigment are excessively aggregated in the conductive paste, conductive paths are not formed efficiently when the positive electrode composite material layer is formed and it is difficult for electrons to flow sufficiently within the electrode. On the other hand, as shown in FIG. 1(c), when the interaction of the primary particles 10 of the conductive pigment is excessively weak and the structure is broken, conductive paths are not formed and it is difficult for electrons to flow sufficiently within the electrode.

Therefore, there is a demand for conductivity aids such as conductive pigments to be appropriately dispersed in the conductive paste such that conductive paths are formed efficiently, as shown in FIG. 1(b).

In FIG. 1, the reference numeral 20 is an active material.

The dispersion state of the conductivity aid in the positive electrode composite material layer is a reflection of the dispersion state of the conductivity aid in the conductive paste. That is, it is possible to form a positive electrode composite material layer in which conductive paths are formed efficiently when using a conductive paste in which a conductivity aid is appropriately dispersed.

Since conductive pastes contain a conductivity aid in a high concentration, in this state, it is difficult to measure the conductivity aid particle size and the dispersion state, such as the distribution of distance between particles. Therefore, for example, it is typical to dilute the conductive paste to perform the particle size distribution measurement or the like and measure the particle size.

However, when diluting the conductive paste, the interaction of the primary particles of the conductivity aid changes, thus, the dispersion state of the conductivity aid in the conductive paste may not be reflected in the measurement results.

The present invention has an object of providing a carbon nanotube dispersion paste with low viscosity, in which carbon nanotubes are appropriately dispersed, and which is capable of forming an electrode for a positive electrode with excellent conductivity, a method for manufacturing a carbon nanotube dispersion paste, a quality control method for a carbon nanotube dispersion paste, a composite material paste, an electrode for a lithium-ion battery positive electrode, and a lithium-ion battery.

The present invention has the following aspects.

[1] A carbon nanotube dispersion paste including carbon nanotubes (B), and an organic solvent (C), in which a content of the carbon nanotubes (B) is 1% to 10% by mass with respect to a total mass of the carbon nanotube dispersion paste, and, in a Bode plot obtained by impedance measurement, in which a reactance is plotted on a vertical axis and a frequency is plotted on a horizontal axis, a local minimum value of the reactance is in a frequency range of 50 to 250 kHz.

[2] The carbon nanotube dispersion paste according to [1], in which the organic solvent (C) is N-methyl-2-pyrrolidone.

[3] The carbon nanotube dispersion paste according to [1] or [2], further including: a pigment dispersion resin (A), in which a content of the pigment dispersion resin (A) is 10 to 100 parts by mass with respect to 100 parts by mass of the carbon nanotubes (B).

[4] The carbon nanotube dispersion paste according to any one of [1] to [3], in which, in the Bode plot, the minimum value of the reactance in the frequency range of 50 to 250 kHz is 5 times or more greater than a value of a reactance at a frequency of 1 kHz.

[5] The carbon nanotube dispersion paste according to any one of [1] to [4], in which a viscosity at a shear rate of 1.0 sec⁻¹ is 10 Pa·s or less.

[6] A method for manufacturing a carbon nanotube dispersion paste containing carbon nanotubes (B) and an organic solvent (C), in which a content of the carbon nanotubes (B) is 1% to 10% by mass with respect to a total mass of the carbon nanotube dispersion paste, and the carbon nanotubes (B) and the organic solvent (C) are mixed and the carbon nanotubes (B) are dispersed such that, in a Bode plot obtained by impedance measurement, in which a reactance is plotted on a vertical axis and a frequency is plotted on a horizontal axis, a local minimum value of the reactance is in a frequency range of 50 to 250 kHz.

[7] A quality control method for a carbon nanotube dispersion paste containing carbon nanotubes (B) and an organic solvent (C), in which a content of the carbon nanotubes (B) is 1% to 10% by mass with respect to a total mass of the carbon nanotube dispersion paste, and the carbon nanotube dispersion paste is controlled such that, in a Bode plot obtained by impedance measurement, in which a reactance is plotted on a vertical axis and a frequency is plotted on a horizontal axis, a local minimum value of the reactance is in a frequency range of 50 to 250 kHz.

[8] A composite material paste including: the carbon nanotube dispersion paste according to any one of [1] to [5], and an electrode active material.

[9] An electrode for a lithium-ion battery positive electrode including: a positive electrode core material, and a layer formed by coating the composite material paste according to [8] on a surface of the positive electrode core material.

A lithium-ion battery including: the electrode for a lithium-ion battery positive electrode according to [9].

### BRIEF DESCRIPTION OF THE DRAWINGS

FIG. 1 are diagrams showing examples of dispersion states of a conductivity aid in a conductive paste and in a positive electrode composite material layer, in which (a) is a diagram showing an example of the dispersion state of a conductivity aid in a case where interaction of the primary particles of the conductivity aid is excessively strong, (b) is a diagram showing an example of the dispersion state of a conductivity aid in a case where interaction of the primary particles of the conductivity aid is appropriate, and (c) is a diagram showing an example of the dispersion state of a conductivity aid in a case where interaction of the primary particles of the conductivity aid is excessively weak.

FIG. 2 are diagrams showing examples of Bode plots obtained by impedance measurement, in which (a) is a diagram showing an example of a Bode plot in a case where the degree of carbon nanotube structure growth is high, (b) is a diagram showing an example of a Bode plot in a case where the degree of carbon nanotube structure growth is medium, and (c) is a diagram showing an example of a Bode plot in a case where the degree of carbon nanotube structure growth is low.

FIG. 3 are diagrams showing examples of Bode plots obtained by impedance measurement, in which (a) is a diagram showing an example of a Bode plot in a case where the particle size of the aggregates of the primary particles of carbon nanotubes (B) is uniform and (b) is a diagram showing an example of a Bode plot in a case where the particle size of the aggregates of the primary particles of the carbon nanotubes (B) is non-uniform.

FIG. 4 is a cross-sectional view of an example of a lithium-ion battery positive electrode with a positive electrode composite material layer for lithium-ion batteries.

FIG. 5 is a cross-sectional view of a lithium-ion battery.

FIG. 6 is a diagram representing Bode plots for Example 4 and Comparative Examples 1 and 3.

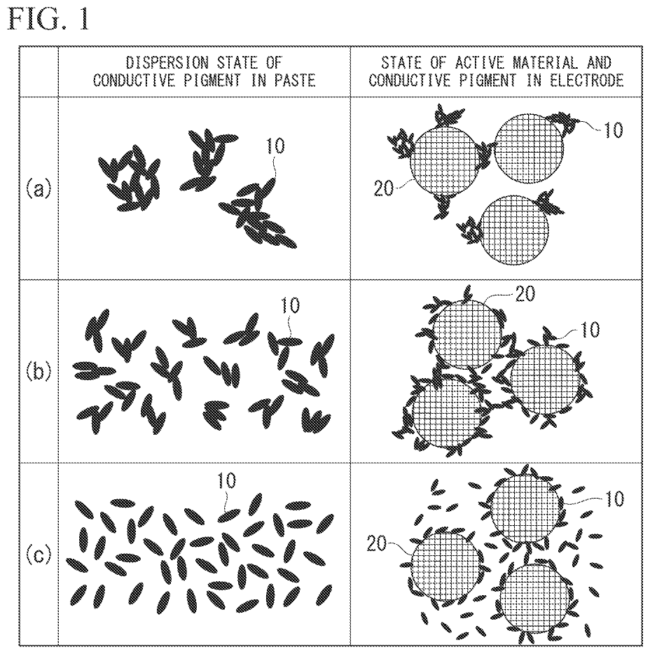

### DETAILED DESCRIPTION OF THE INVENTION

A detailed description will be given of embodiments for implementing the present invention.

It should be understood that the present invention is not limited to the following embodiments, but includes various modified examples implemented in a range not departing from the gist of the present invention.

In addition, in the present specification, “(meth)acrylate” is a generic term for acrylate and methacrylate. “(Meth)acrylic acid” is a generic term for acrylic acid and methacrylic acid. “(Meth)acryloyl” is a generic term for acryloyl and methacryloyl. “(Meth)acrylamide” is a generic term for acrylamide and methacrylamide. “Polymerizable unsaturated monomer” means a monomer having a polymerizable unsaturated group capable of radical polymerization and examples of polymerizable unsaturated groups include (meth)acryloyl groups, acrylamide groups, vinyl groups, allyl groups, (meth)acryloyloxy groups, vinylether groups, and the like. “Derivative” means a compound obtained by changing a small portion (or a plurality of portions) within the molecule by introducing a functional group, substituting atoms, or by another chemical reaction with respect to the compound. For example, a compound in which one or two or more functional groups such as alkyl groups, alkoxy groups, hydroxyl groups, sulfonic acid groups, carboxyl groups, amino groups, nitro groups, halogen atoms, aryloxy groups, alkylthio groups, and arylthio groups are introduced into naphthalene is a naphthalene derivative.

[Carbon Nanotube Dispersion Paste]

The carbon nanotube dispersion paste of the present invention is a conductive paste for lithium-ion battery positive electrodes containing the carbon nanotubes (B) and the organic solvent (C).

The carbon nanotube dispersion paste of the present invention preferably further contains the pigment dispersion resin (A).

The carbon nanotube dispersion paste of the present invention may further contain components (optional components) other than the pigment dispersion resin (A), the carbon nanotubes (B), and the organic solvent (C), as necessary, in a range in which the effect of the present invention is not impaired.

<Carbon Nanotubes (B)>

Examples of the carbon nanotubes (B) include single-layer carbon nanotubes and multi-layer carbon nanotubes. Among the above, multi-layer carbon nanotubes are preferable from the viewpoint of excellent balance of the viscosity, conductivity, and cost of the carbon nanotube dispersion paste.

One of these carbon nanotubes (B) may be used alone or two or more may be used in combination.

From the viewpoint of further improving the dispersibility of the carbon nanotubes (B) and the conductivity of the carbon nanotube dispersion paste, the average outer diameter of the carbon nanotubes (B) is preferably 1 to 25 nm, more preferably 3 to 20 nm, and even more preferably 5 to 15 nm.

In a case where a commercial product is used as the carbon nanotubes (B), the manufacturer's catalog value may be adopted as the average outer diameter of the carbon nanotubes (B).

From the viewpoint of further improving the dispersibility of the carbon nanotubes (B) and the conductivity of the carbon nanotube dispersion paste, the average length of the carbon nanotubes (B) is preferably 0.1 to 100 μm, more preferably 0.5 to 80 μm, and even more preferably 1 to 60 μm.

In a case where a commercial product is used as the carbon nanotubes (B), the manufacturer's catalog value may be adopted as the average length of the carbon nanotubes (B).

The specific surface area of the carbon nanotubes (B) is preferably 1 to 1000 m²/g and more preferably 10 to 500 m²/g. When the specific surface area of the carbon nanotubes (B) is within the range described above, the conductivity of the carbon nanotube dispersion paste will be further improved and the viscosity will be appropriately lowered.

The specific surface area of the carbon nanotubes (B) is the Brunauer-Emmett-Teller (BET) specific surface area as measured by the BET method.

In the BET method, nitrogen is adsorbed as an adsorption gas on the surface of the carbon nanotubes (B) using a specific surface area measuring instrument with a gas adsorption method, the adsorption amount is measured by the BET equation from the relationship between the pressure and adsorption amount at that time, and the specific surface area is calculated.

<Organic Solvent (C)>

As the organic solvent (C), it is possible to suitably use the organic solvent used for polymerization of the resin (A2) described above or a substitution solvent used for solvent substitution after polymerization.

Specific examples of preferable organic solvents (C) include N-methyl pyrrolidone, N-ethyl-2-pyrrolidone, propylene glycol monomethyl ether, methanol, and the like. Among the above, N-methyl-2-pyrrolidone is preferable.

One of these organic solvents (C) may be used alone or two or more may be used in combination.

<Pigment Dispersion Resin (A)>

The pigment dispersion resin (A) is a resin for dispersing the carbon nanotubes (B).

As a pigment dispersion resin (A), it is possible to use any resin that improves the dispersibility of the carbon nanotubes (B) without particular limitation. Specific examples of preferable pigment dispersion resins (A) include acrylic resin, polyester resin, epoxy resin, polyether resin, alkyd resin, urethane resin, silicone resin, polycarbonate resin, silicate resin, chlorine resin, fluorinated resin, polyvinylpyrrolidone resin (PVP), polyvinyl alcohol resin (PVA), polyvinyl acetal resin, composite resins thereof, and the like. Among the above, from the viewpoint of further improving the dispersibility of the carbon nanotubes (B) and appropriately lowering the viscosity of the carbon nanotube dispersion paste, the pigment dispersion resin (A) is preferably a non-cross-linked resin. Among the above, from the viewpoint of further improving the dispersibility of the carbon nanotubes (B) and the storage stability of the carbon nanotube dispersion paste, polyvinyl alcohol resin is particularly preferable as the pigment dispersion resin (A).

One of these pigment dispersion resins (A) may be used alone or two or more may be used in combination.

The polyvinyl alcohol resin may or may not have a modified group.

Below, in the present specification, the polyvinyl alcohol resin without modified groups, that is, unmodified, is also referred to as “polyvinyl alcohol resin (a1)”. In addition, polyvinyl alcohol resins having modified groups are also referred to as “modified polyvinyl alcohol resin (a2)”.

Either one of the polyvinyl alcohol resin (a1) and the modified polyvinyl alcohol resin (a2) may be used as a polyvinyl alcohol resin, or both the polyvinyl alcohol resin (a1) and the modified polyvinyl alcohol resin (a2) may be used in combination.

The polyvinyl alcohol resin (a1) is obtained by polymerizing fatty acid vinyl esters such as vinyl acetate and further saponifying the obtained polymer.

It is possible to manufacture the modified polyvinyl alcohol resin (a2) by any of methods (1) to (4) illustrated below.

(1) Method in which fatty acid vinyl esters such as vinyl acetate and monomers containing other polymerizable unsaturated groups are copolymerized and the obtained polymer is further saponified.

(2) Method in which Michael addition of monomers containing polymerizable unsaturated groups is performed with respect to polyvinyl alcohol.

(3) Method in which acetalization of polyvinyl alcohol is performed with aldehyde compounds.

(4) Method in which a compound having functional groups such as alcohol, aldehyde, and thiol as a chain transfer agent is made to coexist with and polymerize a polyvinyl alcohol.

The modified polyvinyl alcohol resin (a2) preferably contains a side chain having one or more functional groups (modified group) selected from the group consisting of ester groups, amide groups, imide groups, ether groups, hydroxyl groups, carboxyl groups, sulfonic acid groups, phosphoric acid groups, silanol groups, and amino groups.

From the viewpoint of further improving the dispersibility of the carbon nanotubes (B) and the storage stability of the carbon nanotube dispersion paste, the polyvinyl alcohol resin (a1) and the modified polyvinyl alcohol resin (a2) preferably each have a high degree of saponification (high polarity). Specifically, the degree of saponification is preferably 85 mol % or more and less than 100 mol %, more preferably 90 mol % or more and less than 100 mol %, even more preferably 95 mol % or more and less than 100 mol %, and particularly preferably 96 mol % or more and less than 100 mol %.

In the present specification, the “degree of saponification” refers to the ratio of hydroxyl groups with respect to the total number of acetate groups and hydroxyl groups in the polyvinyl alcohol resin.

In addition, the higher the polarity of the pigment dispersion resin (A), the better the adsorption to the carbon nanotubes (B) tends to be, and among the above, the higher the degree of saponification of the polyvinyl alcohol resin (a1) and the modified polyvinyl alcohol resin (a2), the better the adsorption to the carbon nanotubes (B).

From the viewpoint of further improving the dispersibility of the carbon nanotubes (B) and the storage stability of the carbon nanotube dispersion paste, the polyvinyl alcohol resin (a1) and the modified polyvinyl alcohol resin (a2) preferably each have an average degree of polymerization of 50 to 3,000, more preferably 100 to 2,000, and even more preferably 100 to 1,500.

<Optional Components>

Examples of optional components include binding agents (binders), resin components other than the pigment dispersion resin (A) and other than binding agents (other resin components), conductive pigments other than the carbon nanotubes (B) (other conductive pigments), neutralizing agents, antifoaming agents, antiseptic agents, rust inhibitors, plasticizers, and the like.

The binding agent is a resin having an effect of bonding the film obtained by coating the paste to a base material and examples of such resins include acrylic resins other than the pigment dispersion resin (A), polyester resins, epoxy resins, polyether resins, alkyd resins, urethane resins, silicone resins, polycarbonate resins, silicate resins, chlorine resins, fluorinated resins, polyvinylpyrrolidone resins, composite resins thereof, and the like. Among the above, fluorinated resins are preferable and polyvinylidene fluoride (PVDF) is more preferable.

One of these binding agents may be used alone or two or more may be used in combination.

Examples of other conductive pigments include conductive carbon other than the carbon nanotubes (B) (other conductive carbons), and the like.

Examples of other conductive carbons include acetylene black, Ketjen black, furnace black, thermal black, graphene, graphite, and the like.

One of these other conductive carbons may be used alone or two or more may be used in combination.

The average primary particle size of the other conductive carbons is preferably 10 to 80 nm and more preferably 20 to 50 nm. When the average primary particle size of the other conductive carbon is within the range described above, the conductivity of the carbon nanotube dispersion paste will be further improved and the viscosity will be appropriately lowered.

The specific surface area of the other conductive carbon is preferably 1 to 500 m²/g and more preferably 30 to 150 m²/g. When the specific surface area of the other conductive carbon is within the range described above, the conductivity of the carbon nanotube dispersion paste will be further improved and the viscosity will be appropriately lowered.

From the viewpoint of increased pigment dispersibility, the other conductive carbon is preferably basic, specifically, a pH of 7.5 or higher is preferable, 8.0 to 12.0 is more preferable, and 8.5 to 11.0 is even more preferable.

In addition, from the viewpoint of increased conductivity, in the other conductive carbon, the plurality of primary particles are preferably in a state of forming a structure and a structure index of 1.5 to 4.0 is more preferable and 1.7 to 3.2 is particularly preferable.

It is possible to relatively easily observe the structure itself even in images taken with an electron microscope, but the structure index is a numerical value that quantifies the degree of structure. Generally, it is possible to define the structure index as the DBP oil absorption amount (mL/100 g) divided by the specific surface area (m²/g). When the structure index is 1.5 or higher, it is easy to obtain sufficient conductivity due to the developed structure. When the structure index is 4.0 or lower, the particle size does not easily increase with respect to the DBP oil absorption amount, thus, it is possible to suppress a decrease in conductive pathways and it is easy to obtain sufficient conductivity. Moreover, it is possible to suppress the viscosity of the carbon nanotube dispersion paste from becoming excessively high.

<Content>

The content of the carbon nanotubes (B) is 1% to 10% by mass with respect to the total mass of the carbon nanotube dispersion paste, preferably 1.2% to 8% by mass, and more preferably 1.5% to 6% by mass. When the content of the carbon nanotubes (B) is the lower limit value described above or more, the conductivity of the carbon nanotube dispersion paste is increased. When the content of the carbon nanotubes (B) is the upper limit value described above or less, it is possible to favorably maintain the dispersibility of the carbon nanotubes (B).

The content of the carbon nanotubes (B) is preferably 10% to 100% by mass with respect to the total mass of the solid content of the carbon nanotube dispersion paste, more preferably 30% to 95% by mass, even more preferably 50% to 90% by mass, and particularly preferably 60% to 90% by mass. When the content of the carbon nanotubes (B) is the lower limit value described above or more, the conductivity of the carbon nanotube dispersion paste is further increased. When the content of the carbon nanotubes (B) is the upper limit value described above or less, it is possible to more favorably maintain the dispersibility of the carbon nanotubes (B).

“Solid content of the carbon nanotube dispersion paste” means all the components of the components included in the carbon nanotube dispersion paste other than the solvent components (the organic solvent (C) and water).

The content of the organic solvent (C) is preferably 90% to 99% by mass with respect to the total mass of the carbon nanotube dispersion paste, more preferably 92% to 98.8% by mass, and even more preferably 94% to 98.5% by mass. When the content of the organic solvent (C) is the lower limit value described above or more, it is possible to more favorably maintain the dispersibility of the carbon nanotubes (B). When the content of the organic solvent (C) is the upper limit value described above or less, the conductivity of the carbon nanotube dispersion paste is further increased.

In a case where the carbon nanotube dispersion paste contains the pigment dispersion resin (A), the content thereof is preferably 10 to 100 parts by mass with respect to 100 parts by mass of the carbon nanotubes (B), more preferably 12 to 70 parts by mass, and even more preferably 15 to 50 parts by mass. When the content of pigment dispersion resin (A) is the lower limit value described above or more, it is possible to more favorably maintain the dispersibility of the carbon nanotubes (B). When the content of pigment dispersion resin (A) is the upper limit value described above or less, the conductivity of the carbon nanotube dispersion paste is increased.

The moisture content of the carbon nanotube dispersion paste is preferably less than 1% by mass with respect to the total mass of the carbon nanotube dispersion paste, more preferably less than 0.7% by mass, and even more preferably less than 0.5% by mass. The lower the moisture content, the easier it is to favorably maintain a battery performance.

A carbon nanotube dispersion paste in which the moisture content is within the range described above may be a substantially non-aqueous conductive paste.

It is possible to measure the moisture content of the carbon nanotube dispersion paste by the Karl Fischer coulometric titration method. Specifically, using a Karl Fischer moisture content meter (for example, trade name “MKC-610”, manufactured by Kyoto Electronics Manufacturing Co., Ltd.), it is possible to carry out the measurement with the set temperature of 130° C. in a moisture vaporizing apparatus (trade name “ADP-611”, manufactured by Kyoto Electronics Manufacturing Co., Ltd.) provided in the moisture content meter.

<Impedance Spectrum>

The carbon nanotube dispersion paste of the present invention has the feature that, in a Bode plot obtained by impedance measurement, in which a reactance is plotted on a vertical axis and a frequency is plotted on a horizontal axis, a local minimum value of the reactance is in a frequency range of 50 to 250 kHz. The local minimum value of the reactance is preferably in the frequency range of 60 to 200 kHz and more preferably in the frequency range of 70 to 150 kHz.

In the present invention, reactance means the imaginary part of complex impedance.

In a Bode plot, there may be reactance local minimum values at two or more points. In particular, this tendency is remarkable in a case where two or more types of the carbon nanotubes (B) are used in combination, in a case where the carbon nanotubes (B) are used together with another conductive carbon, in a case where the dispersion time of the carbon nanotube dispersion paste is extremely short, or the like. In addition, depending on the type of carbon nanotube (B) to be used, there may be reactance local minimum values at two or more points. In a case where there are reactance local minimum values at two or more points, at least one of the local minimum values may be in the frequency range of 50 to 250 kHz.

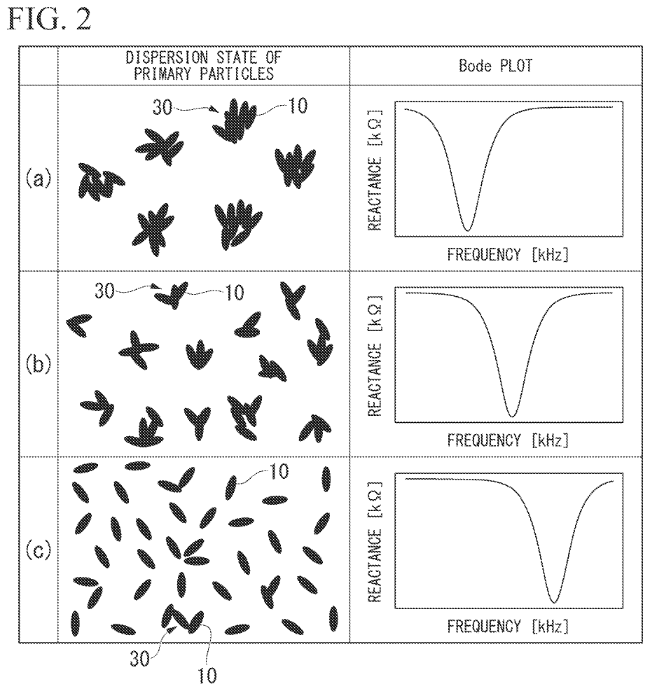

The carbon nanotubes (B) form a structure in the carbon nanotube dispersion paste and the reactance local minimum value in the Bode plot moves according to the degree of growth of the carbon nanotube (B) structure, that is, with the size of the aggregates of the primary particles of the carbon nanotubes (B). For example, as shown in FIG. 2, the stronger the interaction of the primary particles 10 and the higher the degree of structure growth, that is, the larger an aggregate 30 of the primary particles 10 of the carbon nanotubes (B), the greater the tendency for the reactance local minimum value in the Bode plot to more easily move toward the lower frequency region.

FIG. 2(a) is a Bode plot in a case where the degree of structure growth is high, FIG. 2(b) is a Bode plot in a case where the degree of structure growth is medium, and FIG. 2(c) is a Bode plot in a case where the degree of structure growth is low.

In the Bode plot, when there is a reactance local minimum value in the frequency range of 50 to 250 kHz, this means that the structure of the carbon nanotubes (B) is growing appropriately, that is, the primary particles of the carbon nanotubes (B) are dispersed in the carbon nanotube dispersion paste while appropriately maintaining a structure. Thus, when the positive electrode composite material layer is formed using the composite material paste including the carbon nanotube dispersion paste of the present invention, the primary particles of the carbon nanotubes (B) are dispersed in the positive electrode composite material layer while appropriately maintaining the structure. Therefore, conductive paths are formed efficiently and it is possible to form an electrode for a positive electrode with excellent conductivity. In addition, the viscosity of the carbon nanotube dispersion paste also tends to be low.

The Bode plot is obtained, for example, by impedance measurement as shown below.

(Preparation of Measurement Cell)

A two-pole electrode is used in which 0.3 mm thick copper plates with gold-plated surfaces face each other with a distance of 9 mm between the electrodes. The size of the electrodes is 100 mm². 15 ml of the carbon nanotube dispersion paste is filled in a 20 ml cylindrical container and the electrodes are inserted so as to be completely buried in the paste.

(Impedance Measurement)

A sinusoidal AC voltage with a peak-to-peak voltage of 0.1 V is applied to the carbon nanotube dispersion paste at 25° C. using an impedance analyzer and the complex impedance and phase difference are measured at 500 points while the frequency is swept between 100 Hz and 100 MHz. From the obtained data, a Bode plot is created by plotting reactance on the vertical axis and a frequency on the horizontal axis.

In the Bode plot, the minimum value (X) of the reactance in the frequency range of 50 to 250 kHz is preferably −70 to 0 kΩ, more preferably −60 to −3 kΩ, and even more preferably −55 to −5 kΩ.

The value (Y) of the reactance at a frequency of 1 kHz is preferably −20 to 0 kΩ, more preferably −15 to −0.1 kΩ, and even more preferably −13 to −0.2 kΩ.

In the Bode plot, the minimum value (X) of the reactance in the frequency range of 50 to 250 kHz is preferably 5 times or more greater than the value (Y) of the reactance at a frequency of 1 kHz, more preferably 7.5 to 30 times, and even more preferably 10 to 30 times.

As described above, in the Bode plot, there may be reactance local minimum values at two or more points. Even in a case where there are a plurality of local minimum values in the 50 to 250 kHz range, the calculation (X/Y) may be performed at the minimum value in the 50 to 250 kHz range.

The ratio of the value (X) with respect to the value (Y) represented in the expression (X/Y) is preferably 1 to 50, more preferably 3 to 40, and even more preferably 5 to 30.

The ratio of the minimum value (X) with respect to the value (Y) is influenced by the particle size distribution of the aggregates of the primary particles of the carbon nanotubes (B). For example, as shown in FIG. 3(a), the more uniform, that is, aligned, the particle size of the aggregates 30 of the primary particles 10 of the carbon nanotubes (B) is, the larger the ratio of the minimum value (X) with respect to the value (Y) tends to be. On the other hand, as shown in FIG. 3(b), the more non-uniform the particle size of the aggregates 30 of the primary particles 10 of the carbon nanotubes (B) is, the smaller the ratio of the minimum value (X) with respect to the value (Y) tends to be.

When the minimum value (X) is 5 times or more greater than the value (Y), it means that the particle size of the aggregates of the primary particles of the carbon nanotubes (B) in the carbon nanotube dispersion paste is uniform. Thus, when the positive electrode composite material layer is formed using the composite material paste including the carbon nanotube dispersion paste of the present invention, the primary particles of the carbon nanotubes (B) are more uniformly dispersed in the positive electrode composite material layer. Therefore, conductive paths are formed more efficiently and it is possible to form an electrode for a positive electrode with excellent conductivity.

<Viscosity>

From the viewpoint of excellent workability and coatability, the viscosity of the carbon nanotube dispersion paste at a shear rate of 1.0 sec⁻¹ is preferably 10 Pa·s or less and more preferably 5 Pa·s or less. When the viscosity of the carbon nanotube dispersion paste is the upper limit value described above or less, it is possible to suppress the thickening of the composite material paste produced using this paste.

Specifically, the viscosity is preferably more than 0 Pa·s and 10 Pa·s or less, more preferably 0.01 to 7 Pa·s, and even more preferably 0.01 to 5 Pa·s.

The viscosity of the carbon nanotube dispersion paste is a value measured at 25° C. using a cone and plate viscometer.

<Manufacturing Method>

The carbon nanotube dispersion paste is obtained, for example, by uniformly mixing the carbon nanotubes (B), the organic solvent (C), and, as necessary, the pigment dispersion resin (A) and one or more of the optional components using a dispersing machine and dispersing (dispersion treating) the carbon nanotubes (B) such that, in a Bode plot obtained by impedance measurement, a reactance local minimum value is in the frequency range of 50 to 250 kHz. At that time, it is preferable that the carbon nanotubes (B), the organic solvent (C) and, as necessary, the pigment dispersion resin (A) and one or more of the optional components are mixed and the carbon nanotubes (B) are dispersed such that the minimum value (X) is 5 times or more greater than the value (Y).

Through the combination of the blending amount of the carbon nanotubes (B) and the degree of dispersion (dispersion time and the like), it is possible to adjust the frequency at which the reactance local minimum values appear and the value (Y).

Examples of dispersing machines include bead mills, paint shakers, sand mills, ball mills, pebble mills, DCP pearl mills, planetary ball mills, homogenizers, twin-shaft kneading machines, thin-film swirl-type high-speed mixers, and the like, and use is possible without being limited to the above. In addition, among dispersing machines, bead mills or ball mills are preferable in terms of obtaining the desired impedance spectrum in a short time. Examples of bead mills include LMZ mills, dyno mills, and the like, with LMZ mills being preferable.

<Action and Effect>

For the carbon nanotube dispersion paste of the present invention, as described above, the reactance local minimum value is in the frequency range of 50 to 250 kHz in the Bode plot obtained by impedance measurement, thus, the viscosity is low and the primary particles of the carbon nanotubes (B) are dispersed while appropriately maintaining a structure. Thus, when the positive electrode composite material layer is formed using the composite material paste including the carbon nanotube dispersion paste of the present invention, the primary particles of the carbon nanotubes (B) are dispersed in the positive electrode composite material layer while appropriately maintaining the structure. Therefore, conductive paths are formed efficiently, electrons flow sufficiently and easily, and it is possible to form an electrode for a positive electrode with excellent conductivity.

As described above, since conductive paste contains a conductivity aid in a high concentration, it is difficult to measure the particle size of the conductivity aid and the dispersion state such as the distribution of the distance between particles, in this state. Therefore, for example, it is typical to perform the measurement of the particle size distribution and the like by diluting the conductive paste; however, when diluting the conductive paste, the interaction of the primary particles of the conductivity aid changes, thus, the dispersion state of the conductivity aid in the conductive paste may not be reflected in the measurement results.

However, according to the present invention, it is possible to determine the dispersion state of the carbon nanotubes (B) by impedance measurement, without diluting the carbon nanotube dispersion paste, thus, the dispersion state of the conductivity aid in the conductive paste is reflected in the measurement results.

The carbon nanotube dispersion paste of the present invention is suitable as a material for a composite material paste for forming a positive electrode composite material layer which is a part of the electrode.

[Quality Control Method for Carbon Nanotube Dispersion Paste]

For example, a carbon nanotube dispersion paste is quality-controlled such that there is a reactance local minimum value in the frequency range of 50 to 250 kHz in a Bode plot obtained by impedance measurement. At this time, it is preferable to control the quality of the carbon nanotube dispersion paste such that the minimum value (X) is 5 times or more greater than the value (Y).

According to the present invention, it is possible to determine the dispersion state of the carbon nanotubes (B) by impedance measurement, without diluting the carbon nanotube dispersion paste, thus, it is possible to easily control the quality of the carbon nanotube dispersion paste.

The quality control method is not particularly limited, for example, the quality of the carbon nanotube dispersion paste may be controlled by adjusting the frequency at which the reactance local minimum values appear, through the combination of the blending amount of the carbon nanotubes (B) and the degree of dispersion.

[Composite Material Paste]

The composite material paste of the present invention is a composite material paste for a lithium-ion battery positive electrode containing the carbon nanotube dispersion paste of the present invention and an electrode active material as described above.

The composite material paste of the present invention may further contain components (optional components) other than the carbon nanotube dispersion paste of the present invention and the electrode active material as necessary, in a range in which the effect of the present invention is not impaired.

<Electrode Active Material>

Examples of electrode active materials include lithium composite oxides such as lithium nickelate (LiNiO₂), lithium manganate (LiMn₂O₄), lithium cobaltate (LiCoO₂), LiNi_{1/3}Co_{1/3}Mn_{1/3}O₂, and the like.

One of these electrode active materials may be used alone or two or more may be used in combination.

<Optional Components>

Examples of optional components included in the composite material paste include resins, pigments, neutralizing agents, pigment dispersants, antifoaming agents, antiseptic agents, rust inhibitors, plasticizers, antioxidants, viscosity adjusters, and the like.

<Content>

From the viewpoint of further increasing the conductivity and lithium-ion conductivity, for the content of the carbon nanotube dispersion paste in the composite material paste, the content of the carbon nanotubes (B) included in the carbon nanotube dispersion paste is preferably 0.1% to 10% by mass with respect to the total mass of the solid content of the composite material paste, more preferably 0.5% to 8% by mass, and even more preferably 1% to 5% by mass.

“Solid content of the composite material paste” means all the components in the components included in the composite material paste other than the solvent components.

The content of the electrode active material is preferably 40% to 70% by mass with respect to the total mass of the composite material paste, more preferably 50% to 65% by mass, and even more preferably 55% to 65% by mass.

The content of the electrode active material is preferably 80% to 99.5% by mass with respect to the total mass of the solid content of the composite material paste, more preferably 90% to 99% by mass, and even more preferably 95% to 98% by mass.

The content of the solvent components (organic solvent (C), water, and the like) included in the composite material paste is preferably 30% to 60% by mass with respect to the total mass of the composite material paste, more preferably 35% to 50% by mass, and even more preferably 35% to 45% by mass.

<Manufacturing Method>

The composite material paste is obtained, for example, by uniformly mixing and dispersing the carbon nanotube dispersion paste, the electrode active material, and one or more of the optional components and organic solvents as necessary, using a dispersing machine.

Examples of the organic solvent used in the manufacturing of the composite material paste include the organic solvent (C) previously exemplified in the description of the carbon nanotube dispersion paste. The organic solvent used in the manufacturing of the composite material paste and the organic solvent (C) included in the carbon nanotube dispersion paste may be the same type or may be different types, but are preferably the same type.

Examples of dispersing machines include the dispersing machines previously exemplified in the description of the carbon nanotube dispersion paste.

<Action and Effect>

Since the composite material paste of the present invention described above includes the carbon nanotube dispersion paste of the present invention described above, when the positive electrode composite material layer is formed, the primary particles of the carbon nanotubes (B) are dispersed in the positive electrode composite material layer while appropriately maintaining a structure. Therefore, conductive paths are formed efficiently, electrons flow sufficiently and easily, and it is possible to form an electrode for a positive electrode with excellent conductivity.

Although the composite material paste of the present invention is used to form the positive electrode composite material layer, which is a part of the electrode, the composite material paste of the present invention may also be used to form a primer layer provided between the positive electrode core material and the positive electrode composite material layer.

[Electrode for Lithium-Ion Battery Positive Electrode]

The electrode for a lithium-ion battery positive electrode of the present invention has a positive electrode core material and a layer formed by coating the composite material paste of the present invention described above on the surface of the positive electrode core material.

The electrode for a lithium-ion battery positive electrode of the present invention is obtained, for example, by coating the composite material paste of the present invention on the surface of the positive electrode core material and drying the coated composite material paste to form a positive electrode composite material layer on the surface of the composite material paste. The electrode for a lithium-ion battery positive electrode obtained in this manner has a positive electrode core material and a positive electrode composite material layer formed on the surface of the positive electrode core material and this positive electrode composite material layer corresponds to the layer formed by coating the composite material paste of the present invention.

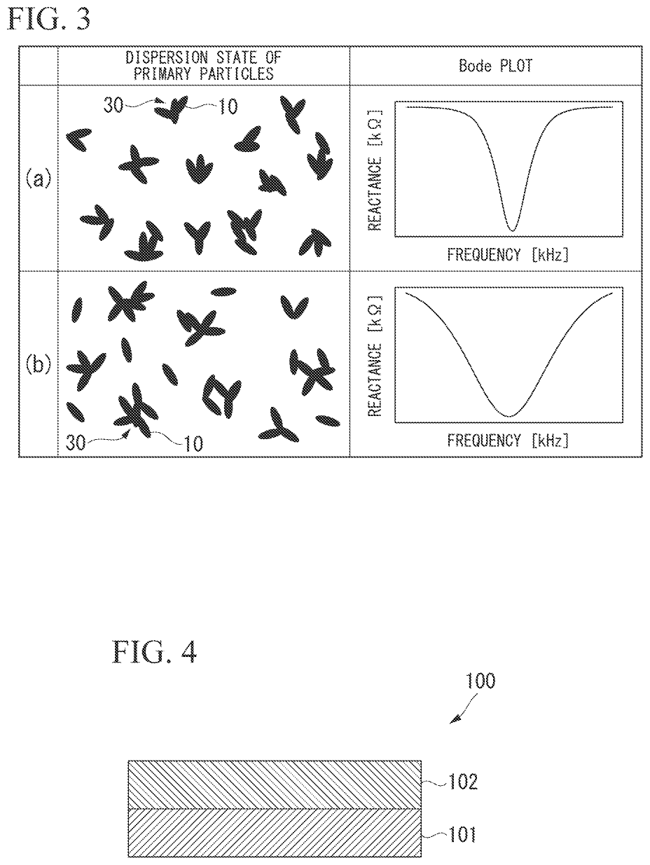

FIG. 4 is a cross-sectional view of an example of a lithium-ion battery positive electrode with a positive electrode composite material layer for lithium-ion batteries. In FIG. 4, the positive electrode 100 for lithium-ion batteries is formed by applying the composite material paste of the present invention to the positive electrode core material 101 to form a positive electrode composite material layer 102 for lithium-ion batteries.

As long as the positive electrode core material is a conductive material, it is not particularly limited; however, metals are preferable and specific examples thereof include aluminum, copper, nickel, iron, titanium, vanadium, chromium, manganese, alloys thereof, and the like.

Examples of the shape of the positive electrode core material include thin-film shapes, reticular shapes, fibrous shapes, and the like. Among the above, the thin-film shapes are preferable.

It is possible to perform the coating method of the composite material paste by a known method using a die coater or the like.

The coating amount of the composite material paste applied is not particularly limited, but for example, the thickness of the positive electrode composite material layer after drying is preferably set to 0.04 to 0.30 mm and more preferably 0.06 to 0.24 mm.

The drying method of the composite material paste is not particularly limited and examples thereof include decompression drying, pressure drying, heating drying, air drying, and the like.

As the temperature (drying temperature) when drying the composite material paste, for example, 80° C. to 200° C. is preferable and 100° C. to 180° C. is more preferable.

As the time (drying time) when drying the composite material paste, for example, 5 to 120 seconds is preferable and 5 to 60 seconds is more preferable.

The electrode for a lithium-ion battery positive electrode of the present invention described above has a layer formed by coating the composite material paste of the present invention described above on the surface of the positive electrode core material, thus, the primary particles of the carbon nanotubes (B) are dispersed in the positive electrode composite material layer while appropriately maintaining a structure. Therefore, in the electrode for a lithium-ion battery positive electrode of the present invention, conductive paths are formed efficiently, electrons flow sufficiently and easily, and the conductivity is excellent.

[Lithium-Ion Battery]

The lithium-ion battery of the present invention has the electrode for a lithium-ion battery positive electrode of the present invention as described above.

The lithium-ion battery of the present invention is obtained, for example, by disposing the electrode for a lithium-ion battery positive electrode of the present invention and the electrode for a negative electrode to be face to face with a permeable separator therebetween and then housing a wound electrode body wound around the above in a roll shape (spiral shape) in a battery case and pouring an electrolyte therein. The lithium-ion battery obtained in this manner is provided with the electrode for a lithium-ion battery positive electrode of the present invention, an electrode for a negative electrode, an electrolyte, a separator, and a battery case that houses the above.

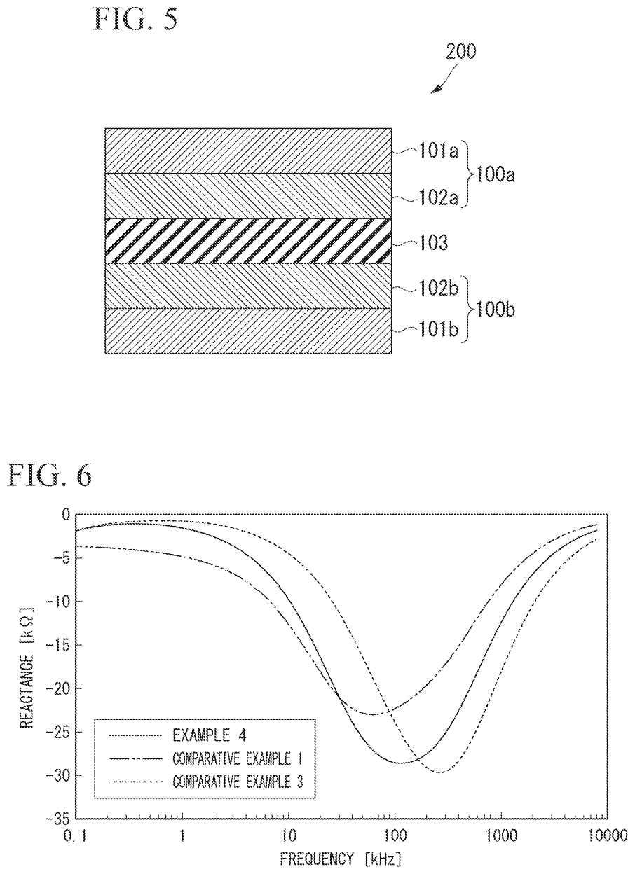

FIG. 5 is a cross-sectional view of a lithium-ion battery. In FIG. 5, the lithium-ion battery is formed by stacking the negative electrode core material 101b, the electrode layer for lithium-ion batteries (negative electrode) 102b, the separator 103, the electrode layer for lithium-ion batteries (positive electrode) 102a, and the positive electrode core material 101a in this order. The negative electrode core material 101b and the electrode layer for lithium-ion batteries (negative electrode) 102b for lithium-ion batteries constitute the negative electrode 100b for lithium-ion batteries, and the positive electrode core material 101a and the electrode layer for lithium-ion batteries (positive electrode) 102a constitute the positive electrode 100a for lithium ion batteries. The electrode layer for lithium-ion batteries (negative electrode) 102b may or may not be formed from the composite paste of the present invention. The separator 103 holds the electrolyte (not shown).

As the electrode for a negative electrode, it is possible to use known electrodes for negative electrodes used in lithium-ion batteries.

As long as the negative electrode core material is a conductive material, it is not particularly limited; however, metals are preferable and specific examples thereof include aluminum, copper, nickel, iron, titanium, vanadium, chromium, manganese, alloys thereof, and the like.

Examples of the shape of the negative electrode core material include thin-film shapes, reticular shapes, fibrous shapes, and the like. Among the above, the thin-film shapes are preferable.

Examples of separators include a porous film manufactured using polyolefins such as polyethylene and polypropylene, and laminated films laminated with the above; non-woven fabrics, and the like.

Examples of the electrolyte include a non-aqueous electrolyte. A non-aqueous electrolyte is a solution in which an electrolyte is dissolved in an organic solvent.

Examples of organic solvents include carbonates such as propylene carbonate, ethylene carbonate, butylene carbonate, dimethyl carbonate, diethyl carbonate, and ethyl methyl carbonate, lactones such as γ-butyrolactone, nitriles such as acetonitrile; esters such as methyl formate, methyl acetate, butyl acetate, methyl propionate, and ethyl propionate; ketones such as acetone and methyl ethyl ketone; amides such as N-methylformamide, N,N-dimethylformamide, and N-methylacetamide, and the like. One of these organic solvents may be used alone or two or more may be used in combination.

Examples of electrolytes include LiClO₄, LiBF₄, LiI, LiPF₆, LiCF₃SO₃, LiCF₃CO₂, LiAsF₆, LiSbF₆, LiAlCl₄, LiCl, LiBr, LiB(C₂H₅)₄, LiCH₃SO₃, LiC₄F₉SO₃, Li(CF₃SO₂)₂N, Li[(CO₂)₂]₂B, and the like. One of these electrolytes may be used alone or two or more may be used in combination.

As a non-aqueous electrolyte, a solution of LiPF₆ dissolved in carbonates is preferable and this solution is particularly suitable as an electrolyte for lithium-ion batteries.

The lithium-ion battery of the present invention described above has the electrode for a lithium-ion battery positive electrode of the present invention described above, thus, conductive paths are formed efficiently, electrons flow sufficiently and easily, and the battery performance is excellent.

### EXAMPLES

A description will be given below of the present invention using Examples, but the present invention is not limited thereto.

[Method for Manufacturing Pigment Dispersion Resin (A)]

### Manufacturing Example 1: Manufacturing of Pigment Dispersion Resin (A1)

100 parts by mass of vinyl acetate as a polymerizable monomer, methanol as a solvent, and azobisisobutyronitrile as a polymerization initiator were added to a reaction container provided with a thermometer, a reflux cooling tube, a nitrogen gas inlet tube, and a stirrer, a copolymerization reaction was performed at a temperature of approximately 60° C., then, unreacted monomer was removed under reduced pressure and a resin solution was obtained. Next, a methanol solution of sodium hydroxide was added to the obtained resin solution to perform a saponification reaction, washing was carried out thoroughly, then drying was carried out in a hot air dryer to obtain a polyvinyl alcohol (a pigment dispersion resin (A1)).

The obtained pigment dispersion resin (A1) had a degree of saponification of 99 mol % and a degree of polymerization of 500.

### Manufacturing Example 2: Manufacturing of Pigment Dispersion Resin (A2)

100 parts by mass of vinyl acetate as a polymerizable monomer, methanol as a solvent, and azobisisobutyronitrile as a polymerization initiator were added to a reaction container provided with a thermometer, a reflux cooling tube, a nitrogen gas inlet tube, and a stirrer, a copolymerization reaction was performed at a temperature of approximately 60° C., then, unreacted monomer was removed under reduced pressure and a resin solution was obtained. Next, a methanol solution of sodium hydroxide was added to the obtained resin solution to perform a saponification reaction, washing was carried out thoroughly, then drying was carried out in a hot air dryer to obtain a polyvinyl alcohol (a pigment dispersion resin (A2)).

The obtained pigment dispersion resin (A2) had a degree of saponification of 90 mol % and a degree of polymerization of 500.

### Manufacturing Example 3: Manufacturing of Pigment Dispersion Resin (A3)

97 parts by mass of vinyl acetate and 3 parts by mass of vinyl sulfonic acid as polymerizable monomers, methanol as a solvent, and azobisisobutyronitrile as a polymerization initiator were added to a reaction container provided with a thermometer, a reflux cooling tube, a nitrogen gas inlet tube, and a stirrer, a copolymerization reaction was performed at a temperature of approximately 60° C., then, unreacted monomers were removed under reduced pressure and a resin solution was obtained. Next, a methanol solution of sodium hydroxide was added to the obtained resin solution to perform a saponification reaction, washing was carried out thoroughly, then drying was carried out in a hot air dryer to obtain a sulfonic acid modified polyvinyl alcohol (a pigment dispersion resin (A3)).

The obtained pigment dispersion resin (A3) had a degree of saponification of 90 mol % and a degree of polymerization of 300.

### Manufacturing Example 4: Manufacturing of Pigment Dispersion Resin (A4)

90 parts by mass of vinyl acetate and 10 parts by mass of 1-pentene-4,5-diol as polymerizable monomers, methanol as a solvent, and azobisisobutyronitrile as a polymerization initiator were added to a reaction container provided with a thermometer, a reflux cooling tube, a nitrogen gas inlet tube, and a stirrer, a copolymerization reaction was performed at a temperature of approximately 60° C., then, unreacted monomers were removed under reduced pressure to obtain a resin solution. Next, a methanol solution of sodium hydroxide was added to the obtained resin solution to perform a saponification reaction, washing was carried out thoroughly, then drying was carried out in a hot air dryer to obtain a diol-modified polyvinyl alcohol (a pigment dispersion resin (A4)).

The obtained pigment dispersion resin (A4) had a degree of saponification of 90 mol % and a degree of polymerization of 300.

[Measurement and Evaluation Methods]

<Measurement of Impedance>

(Preparation of Measurement Cell)

A two-pole electrode system was used in which 0.3 mm thick copper plates with gold-plated surfaces faced each other with a distance of 9 mm between the electrodes. The size of the electrodes was 100 mm². 15 ml of each of the carbon nanotube dispersion pastes obtained in the Examples and Comparative Examples was filled in a 20 ml cylindrical container and the electrodes were inserted so as to be completely buried in the paste.

(Impedance Measurement)

A sinusoidal AC voltage with a peak-to-peak voltage of 0.1 V was applied to each of the carbon nanotube dispersion pastes obtained in the Examples and Comparative Examples at 25° C. using an impedance analyzer (trade name “4294A”, manufactured by Keysight Technologies) and the complex impedance and phase difference were measured at 500 points while the frequency was swept between 100 Hz and 100 MHz. From the obtained data, a Bode plot was created by plotting the reactance on the vertical axis and the frequency on the horizontal axis.

<Measurement of Viscosity>

For each of the carbon nanotube dispersion pastes obtained in the Examples and Comparative Examples, using a cone and plate viscometer (trade name HAAKE MARS III, manufactured by Thermo Fisher Scientific Co., Ltd., 35 mm in diameter, 2° inclined cone and plate), the viscosity was measured at a shear rate of 1.0 sec¹ at 25° C. and evaluated according to the following criteria. S, A, and B are acceptable.

S: Viscosity is less than 1.0 Pa·s.

A: Viscosity is 1.0 Pa·s or more and less than 5.0 Pa·s.

B: Viscosity is 5.0 Pa·s or more and less than 10.0 Pa·s.

C: The viscosity is 10.0 Pa·s or more.

<Measurement of Volume Resistivity>

In the measurement of the volume resistivity, a 5% by mass solution of polyvinylidene fluoride (trade name KF POLYMER L #7305, manufactured by Kureha Corporation, solvent: N-methyl-2-pyrrolidone) was used as the binder.

Each of the carbon nanotube dispersion pastes obtained in the Examples and Comparative Examples and a binder (KF POLYMER L #7305) was weighed, such that the ratio of the mass of the carbon nanotubes (B) in the carbon nanotube dispersion paste to the total mass of the pigment dispersion resin (A) and the polyvinylidene fluoride in the binder (KF Polymer L #7305) in the carbon nanotube dispersion paste was 1:9, and mixed in an ultrasonic homogenizer for 2 minutes to obtain a coating material.

The coating material was applied to a glass plate (2 mm×100 mm×150 mm) using the doctor-blade method and dried by heating at 80° C. for 60 minutes to form a coating film on the glass plate. After measuring the film thickness of the obtained coating film, using an ASP probe (trade name “MCP-TP03P”, manufactured by Mitsubishi Chemical Analytec Co., Ltd.), a resistance value was measured using a resistivity meter (trade name “Loresta-GP MCP-T610”, manufactured by Mitsubishi Chemical Analytec Co., Ltd.) and a resistivity correction factor (RCF) of 4.532 and the film thickness of the coating film were multiplied by the obtained resistance value to calculate the volume resistivity. The volume resistivity was evaluated according to the following criteria. S, A, and B are acceptable.

S: The volume resistivity is less than 5 Ω·cm and the conductivity is extremely favorable.

A: The volume resistivity is 5 Ω·cm or more and less than 10 Ω·cm and the conductivity is favorable.

B: The volume resistivity is 10 Ω·cm or more and less than 15 Ω·cm and the conductivity is normal.

C: The volume resistivity is 15 Ω·cm or more and the conductivity is poor. Alternatively, it was not possible to produce a smooth coating film.

### Examples 1 to 15, Comparative Examples 1 to 11

The pigment dispersion resin (A), the carbon nanotubes (B), and the organic solvent (C) were mixed according to the blending compositions listed in Tables 1 to 4, the carbon nanotubes (B) were dispersed in a ball mill for the dispersion times listed in Tables 1 to 4, and carbon nanotube dispersion pastes (X-1) to (X-15) and carbon nanotube dispersion pastes (Y-1) to (Y-11) were obtained. The blending amounts of the pigment dispersion resin (A) and the carbon nanotubes (B) in the tables are the solid content values. Using each of the obtained carbon nanotube dispersion pastes, the impedance was measured, and, from the obtained Bode plot, the frequency at which the reactance local minimum value (X) is present, the reactance local minimum value (X), the value (Y) of the reactance at a frequency of 1 kHz, and the ratio (X/Y) of the minimum value (X) with respect to the value (Y) were obtained. The results are shown in Tables 1 to 4. For Example 4 and Comparative Examples 1 and 3, the Bode plots are shown in FIG. 6.

In addition, the viscosity measurement and volume resistivity measurement were performed using each of the obtained carbon nanotube dispersion pastes. The results are shown in Tables 1 to 4.

TABLE 1

| | | Example | | | | | | |
|---|---|---|---|---|---|---|---|---|
| | | 1 | 2 | 3 | 4 | 5 | 6 | 7 |
| Carbon nanotube dispersion paste | | X-1 | X-2 | X-3 | X-4 | X-5 | X-6 | X-7 |
| Pigment | A1: PVA (degree of | 1 | 4 | 4 | 4 | 4 | 4 | 4 |
| dispersion | saponification 99 mol %) | | | | | | | |
| resin (A) | A2: PVA (degree of | | | | | | | |
| [parts by mass] | saponification 90 mol %) | | | | | | | |
| | A3: Sulfonic acid modified | | | | | | | |
| | PVA (degree of | | | | | | | |
| | saponification 90 mol %) | | | | | | | |
| | A4: Diol-modified PVA | | | | | | | |
| | (degree of saponification | | | | | | | |
| | 90 mol %) | | | | | | | |
| | A5: Polyacrylate | | | | | | | |
| | A6: PVP | | | | | | | |
| Carbon | B1: ENERMAX 61 | | | | | | | 20 |
| nanotubes (B) | B2: ENERMAX 31 | 10 | 20 | 20 | 20 | 20 | 20 | |
| [parts by mass] | B3: ENERMAX 12 | | | | | | | |
| Organic | N-methyl-2-pyrrolidone | 989 | 976 | 976 | 976 | 976 | 976 | 976 |
| solvent (C) | | | | | | | | |
| [parts by mass] | | | | | | | | |
| Dispersion time [h] | | 3 | 1 | 3 | 6 | 12 | 18 | 12 |
| Impedance | Frequency at which | 76.3 | 53.9 | 76.3 | 114.7 | 132.6 | 205.1 | 132.6 |
| measurement | reactance local minimum | | | | | | | |
| | value (X) is present [kHz] | | | | | | | |
| | Reactance local minimum | −52.3 | −27.6 | −24.5 | −28.6 | −25.7 | −15.4 | −25.7 |
| | value (X) [kΩ] | | | | | | | |
| | Value (Y) of reactance at | −10.3 | −4.4 | −2.0 | −1.5 | −1.1 | −0.6 | −1.1 |
| | frequency of 1 kHz [kΩ] | | | | | | | |
| | Ratio (X/Y) of minimum | 5.1 | 6.2 | 12.0 | 18.5 | 22.9 | 27.9 | 22.9 |
| | value (X) to value (Y) | | | | | | | |
| Evaluation | Viscosity [Pa · s] | 0.01 | 0.33 | 0.04 | 0.02 | 0.01 | 0.01 | 3.22 |
| | Determination | S | S | S | S | S | S | A |
| | Volume resistivity [Ω · cm] | 1.00 | 1.97 | 12.15 | 11.07 | 4.91 | 9.00 | 0.69 |
| | Determination | S | S | B | B | S | A | S |

TABLE 2

| | | Example | | | | | | | |
|---|---|---|---|---|---|---|---|---|---|
| | | 8 | 9 | 10 | 11 | 12 | 13 | 14 | 15 |
| Carbon nanotube dispersion paste | | X-8 | X-9 | X-10 | X-11 | X-12 | X-13 | X-14 | X-15 |
| Pigment | A1: PVA (degree of | 16 | 16 | 16 | 25 | | | | |
| dispersion | saponification 99 | | | | | | | | |
| resin (A) | mol %) | | | | | | | | |
| [parts by mass] | A2: PVA (degree of | | | | | 4 | | | |
| | saponification 90 | | | | | | | | |
| | mol %) | | | | | | | | |
| | A3: Sulfonic acid | | | | | | 4 | | |
| | modified PVA (degree | | | | | | | | |
| | of saponification 90 | | | | | | | | |
| | mol %) | | | | | | | | |
| | A4: Diol-modified | | | | | | | 4 | |
| | PVA (degree of | | | | | | | | |
| | saponification 90 | | | | | | | | |
| | mol %) | | | | | | | | |
| | A5: Polyacrylate | | | | | | | | 4 |
| | A6: PVP | | | | | | | | |
| Carbon | B1: ENERMAX 61 | | | | | | | | |
| nanotubes (B) | B2: ENERMAX 31 | 40 | 40 | 40 | 50 | 20 | 20 | 20 | 20 |
| [parts by mass] | B3: ENERMAX 12 | | | | | | | | |
| Organic | N-methyl-2- | 944 | 944 | 944 | 925 | 976 | 976 | 976 | 976 |
| solvent (C) | pyrrolidone | | | | | | | | |
| [parts by mass] | | | | | | | | | |
| Dispersion time [h] | | 3 | 6 | 12 | 10 | 3 | 3 | 3 | 3 |
| Impedance | Frequency at which | 85.7 | 108.2 | 140.6 | 108.2 | 72.0 | 68.0 | 64.1 | 70.0 |
| measurement | reactance local | | | | | | | | |
| | minimum value | | | | | | | | |
| | (X) is present [kHz] | | | | | | | | |
| | Reactance local | −7.9 | −8.6 | −8.3 | −5.6 | −17.8 | −20.8 | −17.6 | −18.9 |
| | minimum value (X) | | | | | | | | |
| | [kΩ] | | | | | | | | |
| | Value (Y) of reactance | −1.2 | −1.7 | −0.3 | −0.3 | −1.8 | −1.9 | −1.7 | −1.7 |
| | at frequency of 1 kHz | | | | | | | | |
| | [kΩ] | | | | | | | | |
| | Ratio (X/Y) of | 6.6 | 5.1 | 26.0 | 19.7 | 9.9 | 11.2 | 10.1 | 10.8 |
| | minimum value (X) | | | | | | | | |
| | to value (Y) | | | | | | | | |
| Evaluation | Viscosity [Pa · s] | 6.52 | 1.80 | 0.34 | 4.04 | 0.06 | 0.06 | 0.06 | 0.06 |
| | Determination | B | A | S | A | S | S | S | S |
| | Volume resistivity | 13.89 | 10.44 | 10.95 | 14.40 | 13.08 | 10.04 | 13.15 | 6.02 |
| | [Ω · cm] | | | | | | | | |
| | Determination | B | B | B | B | B | B | B | A |

TABLE 3

| | | Comparative Example | | | | | |
|---|---|---|---|---|---|---|---|
| | | 1 | 2 | 3 | 4 | 5 | 6 |
| Carbon nanotube dispersion paste | | Y-1 | Y-2 | Y-3 | Y-4 | Y-5 | Y-6 |
| Pigment | A1: PVA (degree of | 4 | 4 | 4 | 4 | 4 | 4 |
| dispersion | saponification 99 mol %) | | | | | | |
| resin (A) | A2: PVA (degree of | | | | | | |
| [parts by mass] | saponification 90 mol %) | | | | | | |
| | A3: Sulfonic acid | | | | | | |
| | modified PVA (degree of | | | | | | |
| | saponification 90 mol %) | | | | | | |
| | A4: Diol-modified PVA | | | | | | |
| | (degree of saponification | | | | | | |
| | 90 mol %) | | | | | | |
| | A5: Polyacrylate | | | | | | |
| | A6: PVP | | | | | | |
| Carbon | B1: ENERMAX 61 | | | | 20 | 20 | 20 |
| nanotubes (B) | B2: ENERMAX 31 | 20 | 20 | 20 | | | |
| [parts by mass] | B3: ENERMAX 12 | | | | | | |
| Organic | N-methyl-2-pyrrolidone | 976 | 976 | 976 | 976 | 976 | 976 |
| solvent (C) | | | | | | | |
| [parts by mass] | | | | | | | |
| Dispersion time [h] | | 0.5 | 24 | 48 | 1 | 3 | 48 |
| Impedance | Frequency at which | 49.0 | 266.5 | 274.4 | 28.4 | 38.0 | 274.4 |
| measurement | reactance local | | | | | | |
| | minimum value (X) | | | | | | |
| | is present [kHz] | | | | | | |
| | Reactance local | −23.0 | −22.1 | −29.7 | −8.3 | −17.4 | −29.7 |
| | minimum value (X) [kΩ] | | | | | | |
| | Value (Y) of reactance at | −4.9 | −0.6 | −0.8 | −6.3 | −2.3 | −0.8 |
| | frequency of 1 kHz [kΩ] | | | | | | |
| | Ratio (X/Y) of minimum | 4.7 | 40.1 | 38.8 | 1.3 | 7.7 | 38.8 |
| | value (X) to value (Y) | | | | | | |
| Evaluation | Viscosity [Pa · s] | 0.70 | 0.02 | 0.02 | 61.10 | 24.60 | 13.60 |
| | Determination | S | S | S | C | C | C |
| | Volume resistivity | 17.11 | 21.08 | 24.54 | 11.75 | 1.10 | 2.65 |
| | [Ω · cm] | | | | | | |
| | Determination | C | C | C | B | S | S |

TABLE 4

| | | Comparative Example | | | | |
|---|---|---|---|---|---|---|
| | | 7 | 8 | 9 | 10 | 11 |
| Carbon nanotube dispersion paste | | Y-7 | Y-8 | Y-9 | Y-10 | Y-11 |
| Pigment | A1: PVA (degree of | 4 | 4 | 4 | 16 | |
| dispersion | saponification 99 mol %) | | | | | |
| resin (A) | A2: PVA (degree of | | | | | |
| [parts by mass] | saponification 90 mol %) | | | | | |
| | A3: Sulfonic acid modified | | | | | |
| | PVA (degree of | | | | | |
| | saponification 90 mol %) | | | | | |
| | A4: Diol-modified PVA | | | | | |
| | (degree of saponification 90 | | | | | |
| | mol %) | | | | | |
| | A5: Polyacrylate | | | | | |
| | A6: PVP | | | | | 4 |
| Carbon | B1: ENERMAX 61 | | | | | |
| nanotubes (B) | B2: ENERMAX 31 | | | | 40 | 20 |
| [parts by mass] | B3: ENERMAX 12 | 20 | 20 | 20 | | |
| Organic | N-methyl-2-pyrrolidone | 976 | 976 | 976 | 944 | 976 |
| solvent (C) | | | | | | |
| [parts by mass] | | | | | | |
| Dispersion time [h] | | 6 | 12 | 48 | 48 | 3 |
| Impedance | Frequency at which | 490.8 | 463.0 | 930.4 | 299.4 | 40.3 |
| measurement | reactance local minimum | | | | | |
| | value (X) is present [kHz] | | | | | |
| | Reactance local minimum | −11.8 | −12.6 | −2.9 | −11.4 | −18.4 |
| | value (X) [kΩ] | | | | | |
| | Value (Y) of reactance at | −0.6 | −0.5 | −2.8 | −1.6 | −4.6 |
| | frequency of 1 kHz [kΩ] | | | | | |
| | Ratio (X/Y) of minimum | 19.8 | 24.5 | 1.8 | 7.0 | 4.0 |
| | value (X) to value (Y) | | | | | |
| Evaluation | Viscosity [Pa · s] | 0.01 | 0.01 | 2.50 | 0.36 | 1.00 |
| | Determination | S | S | A | S | A |
| | Volume resistivity [Ω · cm] | 115.72 | 42.59 | 98.38 | 59.73 | 20.01 |
| | Determination | C | C | C | C | C |

The abbreviations in the table are as follows. In addition, blank columns in the table mean that the component is not blended therein (0 parts blending amount).
A1: Polyvinyl alcohol obtained in Manufacturing Example 1 (degree of saponification 99 mol %, degree of polymerization 500).
A2: Polyvinyl alcohol obtained in Manufacturing Example 2 (degree of saponification 90 mol %, degree of polymerization 500).
A3: Sulfonic acid modified polyvinyl alcohol obtained in Manufacturing Example 3 (degree of saponification 90 mol %, degree of polymerization 300).
A4: Diol modified polyvinyl alcohol obtained in Manufacturing Example 4 (degree of saponification 90 mol %, degree of polymerization 300).
A5: Polyacrylic acid (weight average molecular weight: 15,000).
A6: Polyvinylpyrrolidone (weight average molecular weight: 30,000).
B1: ENERMAX 61 (manufactured by CABOT, multi-layer carbon nanotubes, average outer diameter: 4 to 16 nm, specific surface area: 230 to 350 cm³/g).
B2: ENERMAX 31 (manufactured by CABOT, multi-layer carbon nanotubes, average outer diameter: 10 to 20 nm, specific surface area: 200 to 260 cm³/g).
B3: ENERMAX 12 (manufactured by CABOT, multi-layer carbon nanotubes, average outer diameter: 30 to 50 nm, specific surface area: 85 to 110 cm³/g).

As is clear from Tables 1 and 2, the carbon nanotube dispersion pastes obtained in each of the Examples had low viscosity, appropriately dispersed carbon nanotubes, low volume resistivity, and excellent conductivity.

On the other hand, as is clear from Tables 3 and 4, the carbon nanotube dispersion pastes obtained in each of the Comparative Examples did not satisfy both viscosity and conductivity.

### EXPLANATION OF REFERENCES

10 PRIMARY PARTICLES
20 ACTIVE MATERIAL
30 AGGREGATE

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A carbon nanotube dispersion paste comprising:
carbon nanotubes (B); and
an organic solvent (C),
wherein a content of the carbon nanotubes (B) is 1% to 10% by mass with respect to a total mass of the carbon nanotube dispersion paste, and,
in a Bode plot obtained by impedance measurement, in which a reactance is plotted on a vertical axis and a frequency is plotted on a horizontal axis, a local minimum value of the reactance is in a frequency range of 50 to 250 kHz.

2. The carbon nanotube dispersion paste according to claim 1,
wherein the organic solvent (C) is N-methyl-2-pyrrolidone.

3. The carbon nanotube dispersion paste according to claim 1, further comprising:
a pigment dispersion resin (A),
wherein a content of the pigment dispersion resin (A) is 10 to 100 parts by mass with respect to 100 parts by mass of the carbon nanotubes (B).

4. The carbon nanotube dispersion paste according to claim 1,
wherein, in the Bode plot, a minimum value of the reactance in the frequency range of 50 to 250 kHz is 5 times or more greater than a value of a reactance at a frequency of 1 kHz.

5. The carbon nanotube dispersion paste according to claim 1,
wherein a viscosity at a shear rate of 1.0 sec⁻¹ is 10 Pa·s or less.

6. A method for manufacturing a carbon nanotube dispersion paste containing carbon nanotubes (B) and an organic solvent (C),
wherein a content of the carbon nanotubes (B) is 1% to 10% by mass with respect to a total mass of the carbon nanotube dispersion paste, and
the carbon nanotubes (B) and the organic solvent (C) are mixed and the carbon nanotubes (B) are dispersed such that, in a Bode plot obtained by impedance measurement, in which a reactance is plotted on a vertical axis and a frequency is plotted on a horizontal axis, a local minimum value of the reactance is in a frequency range of 50 to 250 kHz.

7. A quality control method for a carbon nanotube dispersion paste containing carbon nanotubes (B) and an organic solvent (C),
wherein a content of the carbon nanotubes (B) is 1% to 10% by mass with respect to a total mass of the carbon nanotube dispersion paste, and
the carbon nanotube dispersion paste is controlled such that, in a Bode plot obtained by impedance measurement, in which a reactance is plotted on a vertical axis and a frequency is plotted on a horizontal axis, a local minimum value of the reactance is in a frequency range of 50 to 250 kHz.

8. A composite material paste comprising:
the carbon nanotube dispersion paste according to claim 1; and
an electrode active material.

9. An electrode for a lithium-ion battery positive electrode comprising:
a positive electrode core material; and
a layer formed by coating the composite material paste according to claim 8 on a surface of the positive electrode core material.

10. A lithium-ion battery comprising:
the electrode for a lithium-ion battery positive electrode according to claim 9.
